(19) United States
(12) Patent Application Publication
(10) Pub. No.: US 2005/0008552 A1
(43) Pub. Date: Jan. 13, 2005

(54) Diffusion-enabled ingestion inhibitor

(76) Inventors: Jon C. Marine, Fullerton, CA (US); James P. Mills-Winkler, Long Beach, CA (US)

Correspondence Address: KOLISCH HARTWELL, P.C., 520 S.W. YAMHILL STREET, SUITE 200, PORTLAND, OR, 97204, US

(21) Appl. No.: 10/883,395

(22) Filed: Jun. 30, 2004

Related U.S. Application Data
(60) Provisional application No. 60/485,673, filed on Jul. 7, 2003.

(51) Int. Cl. B01D 11/02

(52) U.S. Cl. 422/261; 422/276

(57) ABSTRACT

A tablet holder including a plurality of perforations that allow diffusion of an enclosed tablet into a surrounding liquid through the perforations. The holder includes a retainer portion and an extension portion that engages selectively with the retainer portion and extends therefrom. In some embodiments, the extension portion extends parallel to a plane formed by a diffusion surface in the retainer portion.

### CROSS-REFERENCE TO RELATED APPLICATIONS

This application claims priority under 35 U.S.C. 119(e) to U.S. Provisional Patent Application No. 60/485,673 entitled “Diffusion-Enabled, Ingestion Inhibitor,” filed Jul. 7, 2003, the disclosure of which is incorporated herein by reference.

### BACKGROUND

Young children may perceive a chemical tablet, such as those used to die fabrics, as a piece of candy and may subsequently attempt to eat the tablet. While in some cases the tablet may be quite harmless if ingested, swallowing of the tablet is undesirable both to prevent the risk that ingestion of the tablet may harm the child and to prevent possible choking. This disclosure relates generally to substance holders, and more specifically, to holders that allow dispensing of a held substance into and out of the holder, such as through diffusion, while decreasing the likelihood of ingestion. Containers for dispensing chemicals or restricting flow through a holder are found in U.S. Pat. Nos. 3,165,910, 3,657,994, 4,350,666, 4,555,819, 4,860,929, 5,593,648, 5,623,865 and 6,024,012, the disclosures of which are incorporated herein by reference.

### SUMMARY

The present discloser is directed to a tablet holder. The tablet holder includes a retainer portion and an extension portion that is adapted to engage selectively with the retainer portion and extend therefrom in a plurality of directions. In some embodiments, the extension portion extends parallel to a plane formed by a diffusion surface in the retainer portion.

### BRIEF DESCRIPTION OF THE DRAWINGS

FIG. 1 depicts a tablet holder according to the present description used in dying clothing for a doll.

FIG. 2 shows an isometric view of a tablet holder having an extension portion and a retainer portion with a diffusion surface.

FIG. 3 depicts a cross-sectional view taken along line A-A of FIG. 2 showing an alternate embodiment where the retainer portion and the extension portion are integrally formed, and the extension portion is angled toward the retainer portion.

FIG. 4 shows a top view of an alternate embodiment of the tablet holder where the retainer portion and the extension portion form multiple chambers.

FIG. 5 depicts a cross-sectional view of the chambers taken along line B-B of FIG. 4.

FIG. 6 illustrates an alternate embodiment of the tablet holder where the diffusion surface is integral with the extension portion.

FIG. 7 illustrates an alternate embodiment of the tablet holder where the retainer portion is between two extension portions having continuous out-of-plane flanges.

### DETAILED DESCRIPTION

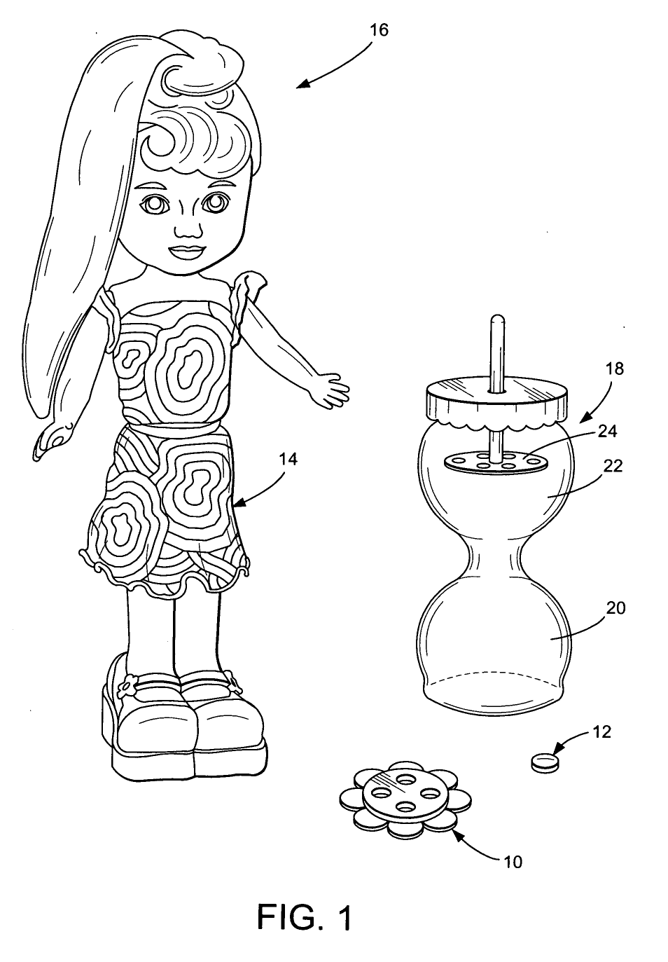

FIG. 1 shows a tablet holder 10 that may be used to house a chemical tablet 12 that is suitable for use in dyeing of textile materials 14, such as clothing for a doll 16. Thus children who enjoy both crafts and playing with dolls have increased play options. In some embodiments, holder 10 is designed to be used with an hourglass-shaped mixing container 18. In such a configuration a user may place holder 10, containing tablet 12, into a bottom reservoir 20 of mixing container 18 with water. Clothing 14 may then be placed in a top reservoir 22 and subsequently invert mixing container 18 so that the diffused dye will cover clothing 14. When dying is complete, mixing container 18 is turned right-side-up and a squeezer 24 may be used to press clothing 14 against the narrow region of mixing container 18 to remove extra liquid.

Although the disclosed holder may be used to encase any substance for controllably dispensing a compound when submerged in a liquid, the following discussion will focus on holder 10 in appropriate configurations for uses similar to that previously discussed, thereby preventing young children, who may perceive a chemical tablet as a piece of candy, from eating tablet 12. Therefore, users are protected by limiting access to the holder's contents while diffusion is allowed through the holder to maintain complete functionality of the substance contained within the holder during use.

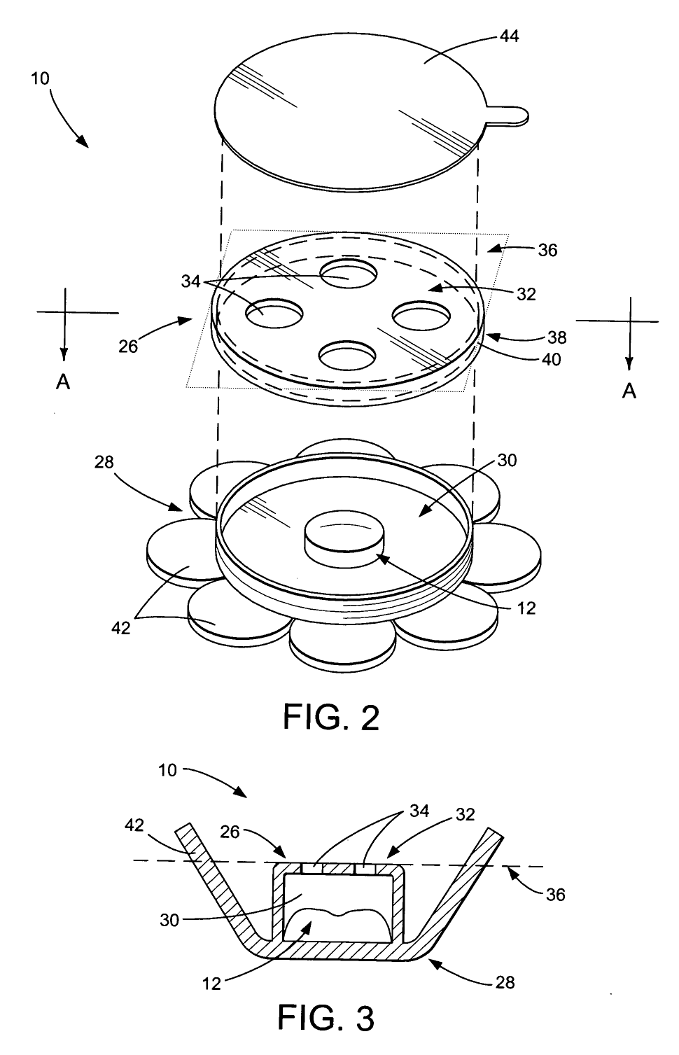

As depicted in FIG. 2, tablet holder 10 is comprised of a first portion, such as a hollow retainer or cover portion 26, and a second portion, such as an extension or base portion 28. Retainer portion 26 and extension portion 28 are adapted to engage selectively with each other to form a chamber or pocket 30 to hold tablet 12. Chamber 30 may be formed by the combination of retainer portion 26 and extension portion 28 or may be formed completely within retainer portion 26. As shown, chamber 30 provides room for insertion and movement of one or more tablets 12 and thus provides adequate space for flow of liquid around one or more tablets within chamber 30, so that the chemicals of tablet 12 will dissolve.

At least one surface of holder 10 is considered a diffusion surface 32, as shown in FIG. 2, and has perforations or apertures 34 therethrough. Diffusion surface 32 may form a plane 36, across which fluid flows. In some embodiments diffusion surface 32 is typically part of hollow retainer portion 26 and is further bounded by an outer periphery 38, such as sidewalls 40, thus forming at least a portion of chamber 30.

Extension portion 28 is configured to extend away from retainer portion 26 to restrict ingestion of the holder and the tablet it contains. This may be accomplished by extension portion 28 including one or more flanges 42 extending beyond outer periphery 38 of retainer portion 26 in a plurality of directions. In some embodiments flanges 42 extend in directions parallel to plane 36, formed by the diffusion surface of retainer portion 26.

During use, holder 10 and encased tablet 12 are placed in a container of liquid, such as water, as previously described. Tablet 12 is able to dissolve because the liquid enters and exits holder 10 through perforations 34 that provide access to tablet 12. The number and size of perforations 34 may be selected to allow relatively uninhibited movement of water into and out of chamber 30 so that tablet 12 may quickly dissolve and be dispensed. Alternatively, the number and size of perforations 34 may be designed to limit the rate at which the chemicals of tablet 12 are dispensed.

Perforations 34 may be of any shape or dimension as long as tablet 12 is fully contained within holder 10 prior to use. In the embodiments shown, the tablet remains in chamber 30 until the majority of diffusion is complete. Prior to use, perforations 34 may be blocked to prevent moisture from entering chamber 30. This may be achieved by barrier 44, shown in FIG. 2 as being a piece of tape, attached to retainer portion 26 over the perforations.

Retainer portion 26 and extension portion 28 may be adapted to allow a user to selectively access chamber 30 by separating the retainer portion from the extension portion 28. Thus, retainer portion 26 may be separable from flanges 42 of extension portion 28, such that flanges 42 may also be used to open chamber 30 to allow an adult to insert a replacement tablet 12 by prying or twisting flanges 42. In some embodiments, such as that shown in FIG. 2, retainer portion 26 and extension portion 28 are threaded. Prior to use, replacement tablet 12 may be stored in a secondary container to prevent ingestion and protect the tablet until needed.

The shape and size of holder 10 may assist in preventing swallowing or other methods of ingesting the chemicals of tablet 12. For example, flanges 42 may protrude sufficiently far away from retainer portion 26 that holder 10 is incapable of entering or lodging in a child's throat. To accomplish this, some embodiments include at least two flanges extending in opposing directions. Although flanges 42, as shown in FIG. 2 are arcuate, flanges 42 may be of any shape and number or be a continuous uniform extension. Flanges 42 may be used for decorative purposes and be adapted to represent flower petals, such as the daisy shape shown in FIG. 2. Thus, the candy-like appearance of tablet 12 is concealed by an appearance of, holder 10 unrelated to food, thereby limiting a child's temptation to eat tablet 12.

Flanges 42 may also be used to facilitate motion of holder 10 within a container of liquid to increase mixing of the tablet chemicals with the surrounding liquid. Additionally, an out-of-plane flange 42, such as that shown in FIG. 3, may prevent holder 10 from seating against an inner wall of a mixing vessel that could cover perforations 34, thereby restricting diffusion.

As shown in FIG. 3, extension portion 18, or one or more of flanges 42, may be angled with respect to plane 36 formed by diffusion surface 32 so that some of extension portion 28 crosses plane 36, thereby restricting access to perforations 34. In this manner, the likelihood of ingestion of tablet 12, such as by licking or sucking through perforations 34, is limited since it is more difficult for a child to place his or her mouth on the perforations. FIG. 3 is intended as an example only and it should be appreciated that the angle between flanges 42 and sidewalls 40 and the length of flanges 42, is not limited to that depicted.

In some embodiments, holder 10 includes a fully integrated retainer portion 26 and extension portion 28, as shown in FIG. 3. In such a configuration, tablet 12 may be trapped inside chamber 30 at the point of production, such as by injection of a liquid form of tablet 12 through perforations 34, so that it is difficult for the user to access tablet 12.

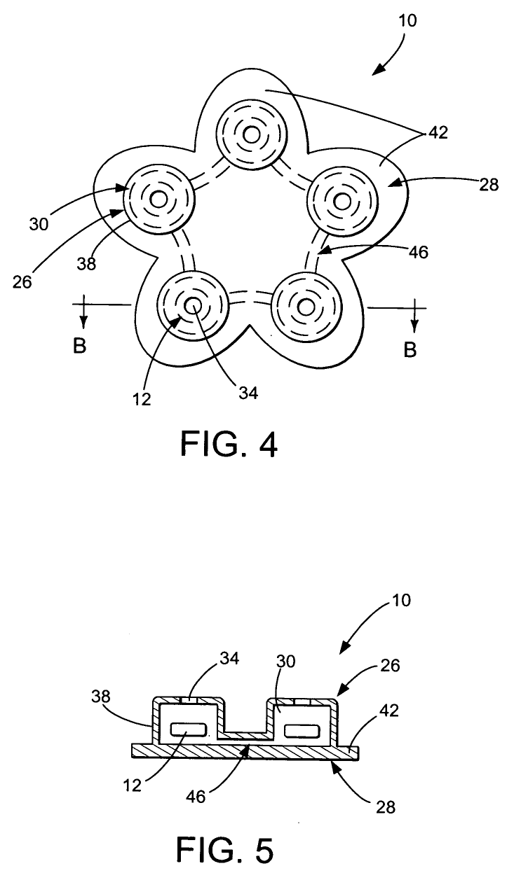

In the example shown in FIGS. 4 and 5, as in the previous examples, holder 10 includes retainer portion 26 and extension portion 28. A plurality of flanges 42 extend beyond outer periphery 38 of retainer portion 26. Holder 10 may have several chambers 30 capable of each holding a tablet 10 for increased chemical diffusion. The chambers may be joined by channels 46 to promote fluid flow between chambers 30.

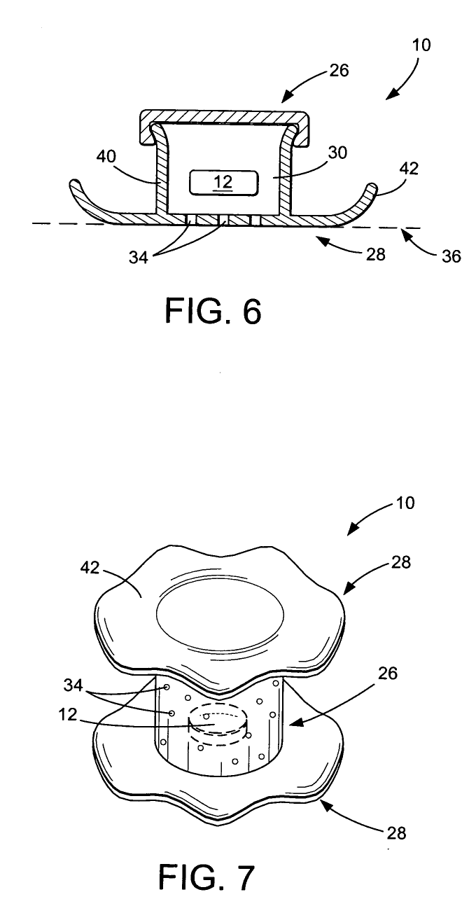

As shown in FIG. 6, perforations 34 may be incorporated into the same portion as flanges 42. Thus extension portion 28 forms diffusion surface 32 while retainer portion 26 forms a snap closure cover. Additionally, flanges 42 may curve away from diffusion plane 36.

In still other embodiments, an extension portion 28 may be connected to both ends of retainer portion 26, such as the spool-like configuration shown in FIG. 7. This may further restrict access to tablet 12 and more closely resemble a toy.

In the case of a dye tablet holder, retainer portion 26 and/or extension portion 28 may be colored to indicate the color of dye contained. Alternatively, at least a region of retainer portion 26 or extension portion 28, depending on the location of chamber 30, is translucent so that the color of tablet 12 and its diffusion progress are directly viewable.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

1. A tablet holder comprising:
a hollow retainer portion having an outer periphery and a diffusion surface, the diffusion surface having a plurality of perforations therethrough; and
an extension portion adapted to engage selectively with the retainer portion and extend therefrom so that the extension portion extends substantially beyond the outer periphery of the retainer portion in a plurality of directions.

2. The tablet holder of claim 1, wherein the plurality of directions are parallel to a plane formed by the diffusion surface of the retainer portion.

3. The tablet holder of claim 1, wherein the retainer portion and the extension portion form a chamber therebetween, the chamber being sized to provide adequate space for fluid flow around one or more tablets within the chamber.

4. The tablet holder of claim 3, wherein the retainer portion and the extension portion are adapted to allow a user to selectively access the chamber by separating the retainer portion from the extension portion.

5. The tablet holder of claim 4, wherein the extension portion and the retainer portion are threaded.

6. The tablet holder of claim 1, wherein the extension portion is angled with respect to a plane formed by the diffusion surface of the retainer portion so that some of the extension portion crosses the plane.

7. The tablet holder of claim 1, wherein the extension portion is comprised of at least two opposing flanges.

8. The tablet holder of claim 7, wherein the flanges are adapted to represent flower petals.

9. The tablet holder of claim 1, wherein the retainer portion is adapted to hold a dye tablet and at least one of the retainer portion and the extension portion is colored to indicate the color of the dye tablet contained within the retainer portion.

10. The tablet holder of claim 1, wherein at least a region of the retainer portion is translucent and thereby adapted to allow a user to view any contents of the chamber.

11. A tablet holder comprising:
a first portion; and
a second portion, wherein the first portion and the second portion operatively engage to form a plurality of chambers therebetween, at least one of the first and second portions having a plurality of perforations, and at least one of the first and second portions including two or more flanges extending away from the other of the first and second portions in opposing directions.

12. The tablet holder of claim 11, wherein the plurality of chambers are joined by channels adapted to allow fluid flow between the plurality of chambers.

13. The tablet holder of claim 11, wherein at least one of the flanges is angled with respect to a plane formed by the plurality of perforations so that the at least one flange crosses the plane, thereby restricting access to the perforations.

14. The tablet holder of claim 11, wherein the flanges are arcuate.

15. The tablet holder of claim 11, wherein the tablet holder is adapted to hold a dye tablet and at least one of the first and second portions is colored to indicate the color of the dye tablet contained within the holder.

16. The tablet holder of claim 11, wherein at least one of the first and second portions is translucent and thereby adapted to allow a user to view any contents of the holder.
